(19) United States
(12) Patent Application Publication
(10) Pub. No.: US 2007/0107050 A1
(43) Pub. Date: May 10, 2007

(54) Simple two-factor authentication

(75) Inventor: Balamurugan Selvarajan, Bangalore, IN (US)

Correspondence Address: Lee Hagelshaw;Suite 406, 350 Townsend Street, San Francisco, CA, 94107, US

(73) Assignee: Jexp, Inc., Pleasanton, CA (US)

(21) Appl. No.: 11/267,148

(22) Filed: Nov. 7, 2005

(51) Int. Cl. H04L 9/32; G06K 9/00; H04L 9/00; G06F 17/30; G06F 15/16; H04K 1/00; G06F 7/04; G06F 7/58; G06K 19/00

(52) U.S. Cl. 726/5; 726/6; 726/7; 713/166; 713/151; 713/182; 726/9

(57) ABSTRACT

Internet Security is increasingly of concern as more and more cases of identity theft of online data is reported. Simple login and password authentication for access to sensitive websites like financial, health or other personal data is no longer sufficient. Several mechanisms for additional security, called two-factor authentication have been proposed. Most of them involve the use of a physical device like a card which is read by a card reader or suggest the use of biometric authentication. Although, these are very secure, the cost of implementation of these “physical” authentications is high. This invention outlines the use of a simple two factor authentication using mobile phones, PDAs or Credit and Debit cards that most users already have, without the need for any special hardware.

### BACKGROUND OF THE INVENTION

1. Field of the Invention

The present invention relates to securing logins to sensitive websites and more specifically to a simple, cost-effective form of two-factor authentication.

2. Description of Related Art

The concept of two-factor authentication is well known and there are several inventions relating to it. However, most of the inventions require the use of special hardware like card reader, biometric reader, etc and are expensive. There are also software only solutions like the use of client side certificates. Although these provide a good deal of security, these require the user to install the certificate on his or her computer. Additionally, the client-side certificates cannot be moved across computers, thereby limiting its use for users that travel frequently. Another invention in this area relates to sending a confirmation code to the user's phone by SMS and verifying this code before authentication. Although this provides a simple solution without the need for any special hardware, the service provider will incur a cost on each SMS sent, which could be very high for a large service provider with several thousand logins per day.

### BRIEF SUMMARY OF THE INVENTION

The present invention provides a economical two-factor authentication to secure access to sensitive websites that contain financial, health or other sensitive data. This authentication is over and above the typical login and password authentication and provides additional security that would help eliminate Internet fraud.

Typical two-factor authentication involves as the first step, something the user “knows”, like a password or PIN and as the second step, something the user “has”. Prior art in this area suggest solutions that include card readers, finger print scanners, etc. The additional hardware, in most cases, is expensive and the cost has to be borne by the service provider or the user.

This invention proposes the use of something the user already “has”, like a cell phone, Internet enabled PDA, a credit card, etc. As a first step, the user registers such a device with the service provider. If the service provider already has the information from prior registration or from virtue of their providing a certain type of service (e.g, a Bank may already have the Credit Card or Debit Card number of the card issued to the user), then the registration step is not required.

Whenever the user tries to login to the service provider's web site, the service provider requests for the login and password. But before completing the authentication and granting access to the service, the service provider tries to authenticate the “device”. Access is granted only if the device authentication is successful, otherwise access to the service is denied. The verification process can take several forms: in one embodiment, the user visits a service provider URL with their registered device to receive a unique confirmation code which they need to enter on the website before completing the authentication. Alternatively, the user can be asked to enter random digits (e.g 1^{st}, 12^{th} and 16^{th} digit of their debit card) as part of the second step.

### BRIEF DESCRIPTION OF THE DRAWINGS

FIG. 1: Shows the interaction process of the present invention

FIG. 2: Shows the device registration process

FIG. 3: Shows an example authentication in the present invention using in-bound SMS

FIG. 4: Shows an example authentication in the present invention using WAP/WML

FIG. 5: Shows an example authentication in the present invention using an ATM card

### DETAILED DESCRIPTION OF THE INVENTION

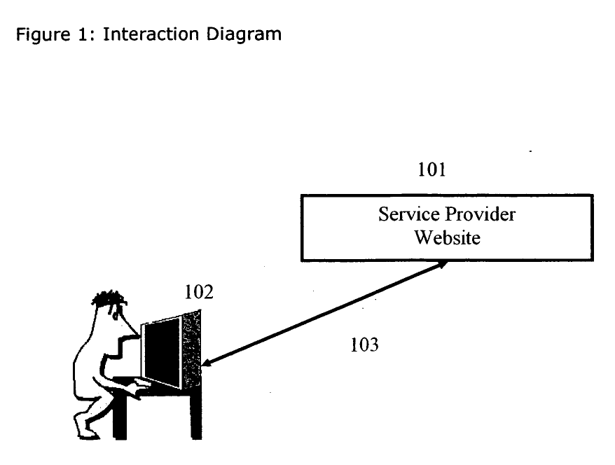

FIG. 1 is a diagram illustrating an interaction model for one embodiment of the present invention. The system includes a service provider #101 and a user #102 interacting with the service provider website using a browser or similar software. The system also includes the communications link #103.

The link #103 communicatively couples the browser #130 and the service provider, preferably over the Internet. The service provider may include one or more of the following: a central processing unit (“CPU”), a memory, a port, a communications interface and an internal bus. Of course, in an embedded system, some of these components may be missing, as is well understood in the art of embedded systems. In a distributed computing environment, some of these components may be on separate physical machines, as is well understood in the art of distributed computing.

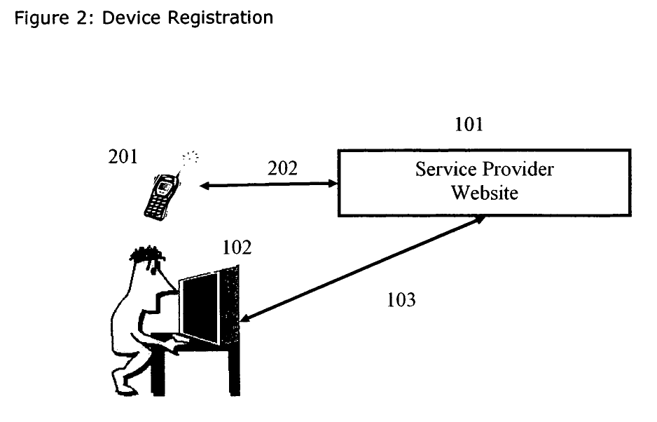

FIG. 2 illustrates the registration process. In one embodiment of the system, the user registers a device like a phone with the service provider by logging in to the service provider website using their login id and password and entering the phone number in the browser.

Alternatively, the user can visit a Uniform Resource Locator (URL) of the service provider using a WAP enabled phone #201. The system would prompt the user for a login and password. The user enters this information from the phone. Upon entering the information, the service provider website validates the user and registers the device by using the unique identifier for the device. The communication link #202 in this example would be WAP till the gateway and TCP/IP from the gateway to the service provider.

In another embodiment of the system, the user registers a card number with the service provider (e.g Credit Card or ATM card). If the service provider already has the card information by virtue of their service (for e.g a Bank would already have the card number of the credit/ATM card it has issued to a user), this step can be bypassed and the user can optionally specify to the service provider to use this card for the two-factor authentication.

The user has the option of specifying or modifying which device to use for the authentication and which form the authentication token should take (e.g SMS, email, online, WAP, etc).

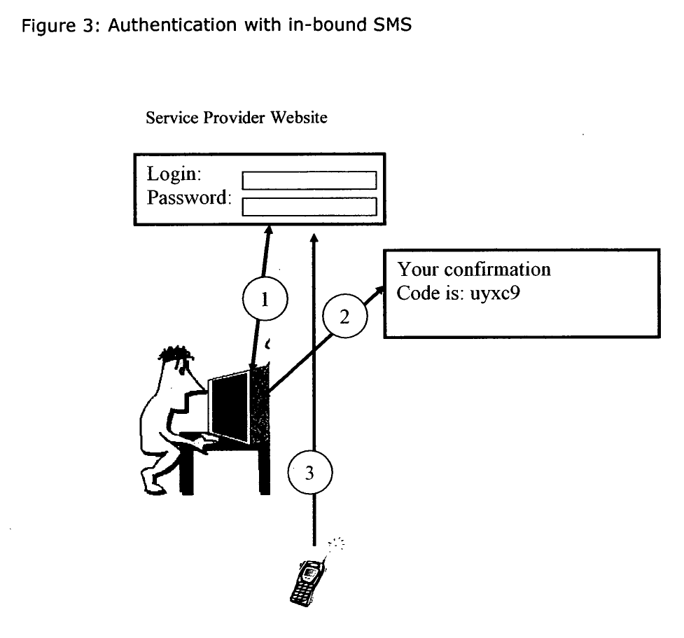

FIG. 3 illustrates an example of the two-factor authentication process in one embodiment of the system. In step 1, the user enters the login and password as they do normally. In step 2, the service provider displays a unique confirmation on the website and requests the user to send that code to a service provider's number. In step 3 of the authentication process, the user sends this code from their registered device before he or she can gain access to the website. When the message is received, the service provider validates the confirmation code and the originating phone before granting access to the user.

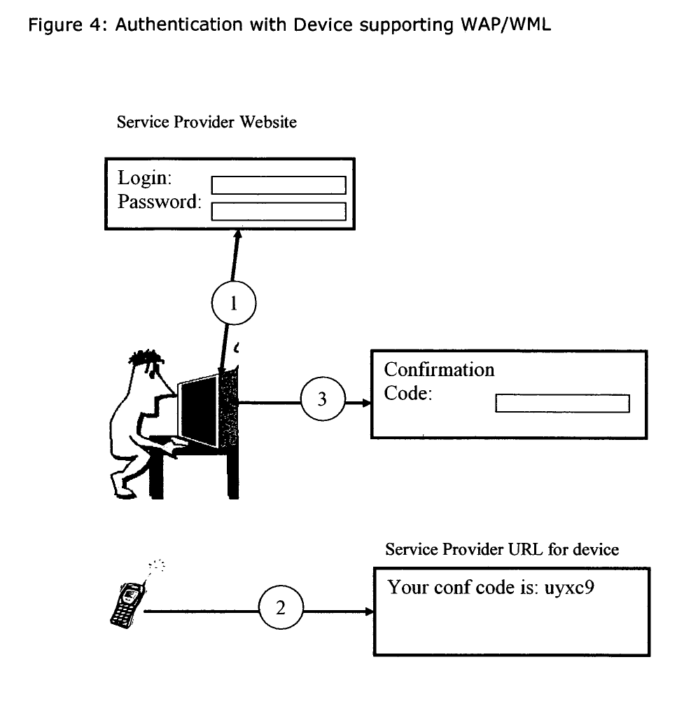

FIG. 4 illustrates an example of the two-factor authentication process in another embodiment of the system. In step 1, the user enters the login and password as they do normally. In step 2, the user visits a URL of the service provider using the WAP/WML enabled phone. The confirmation code is displayed on the device. In step 3, the user has to enter this confirmation number on the website as part of the authentication process to gain access. Steps 1 and 2 of in this embodiment are interchangeable.

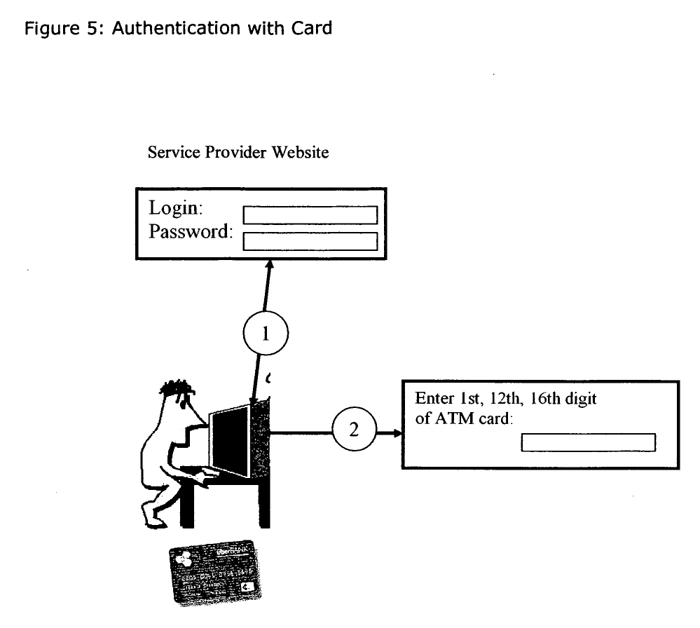

FIG. 5 illustrates an example of the two-factor authentication process in yet another embodiment of the system. In step 1, the user enters the login and password as they do normally. In step 2, the service provider requests the user to enter some randomly chosen digits from the card they registered earlier. If they match, the user is granted access, otherwise access is denied.

This invention provides a simple, cost-effective and portable solution for two factor authentication. Unlike other prior art in this area, this solution does not require any special hardware or any special software setup or customization from the user. Unlike the out-going SMS model, this invention avoids any additional cost to the service provider.

In addition this solution will also provide protection to the users against fake websites and phishing attacks. For example, if the website visited by the user does not request for the two-factor authentication using the device and the mechanism specified by the user, it could mean that the originating website is not be the real one.

I claim:

1. A method for logging into a website securely with a second level of authentication in addition to the typical login id and password, comprising of: a user that desires to login and a service provider that provides the secure website.

2. The method of claim 1, further comprising of the said user registering a phone or a PDA or other Internet enabled device with the service provider to enable two-factor authentication for future logins.

3. The method of claim 2, wherein, before the step of authentication is complete, the user visits a service provider URL using the said registered device to obtain a confirmation code through the device and which the user enters on to the website to complete the authentication.

4. The method of claim 3, alternatively comprising, the service provider displaying a confirmation code on the website and requesting the user to send it to the service provider from the user's registered device (using SMS or other methods) to complete the authentication.

5. The method of claim 2, alternatively comprising of, the user registering a credit, debit or other electronic card or just authorizing the service provider if the service provider already has the card information.

6. The method of claim 5, wherein, before the step of authentication is complete, the service provider requests the said user to enter some randomly chosen digits from the said card, which is verified before completing authentication.
